(19) United States
(12) Patent Application Publication
(10) Pub. No.: US 2008/0269945 A1
(43) Pub. Date: Oct. 30, 2008

(54) AUTOMATIC PHOTOMASK TRACKING SYSTEM AND METHOD

(76) Inventors: Tung-Huan Lai, Shulin City (TW); Kang-Ning Hsieh, Shulin City (TW)

Correspondence Address: SINORICA, LLC, 528 FALLSGROVE DRIVE, ROCKVILLE, MD, 20850, US

(21) Appl. No.: 12/104,609

(22) Filed: Apr. 17, 2008

(30) Foreign Application Priority Data
Apr. 27, 2007 (TW) 096115029

(51) Int. Cl. G06F 17/00

(52) U.S. Cl. 700/215

(57) ABSTRACT

An automatic photomask tracking system is disclosed in the present invention. The automatic photomask tracking system is used in a photomask handling system. The photomask handling system includes photomask pods and photomask handling apparatuses. The photomask tracking system includes a control terminal; at least one RFID tag on the photomask pod and at least one RFID reader on the photomask apparatus. All the record of photomask handling process is stored in the control terminal. The present invention further provides a photomask tracking method.

### BACKGROUND OF THE INVENTION

1. Technical Field

The present invention relates to a photomask tracking system and a method thereof and, more particularly, to an automatic photomask tracking system and a method thereof.

2. Description of Related Art

In a modernized and advanced foundry or fab, photomasks are requisite for producing wafers. The “optical lithography”, which is to be applied to wafer manufacture, involves making a photomask with a designed wire pattern, and accurately duplicates the wire pattern on a wafer by projection of optical image principle. Therefore, photomasks play a crucial role in producing wafers and the quality of the wafer can be significantly affected by the conditions of the photomasks.

Since photomasks are typically expensive in both of their manufacturing costs and selling prices, it would be an important task to extend a use life of photomasks by efficiently managing or recording a photomask handling process.

At present, procedures of photomask handling and transporting depend upon manual recording, which tends to lead mistakes and even a minute mistake in the photomask handling and transporting procedures can adversely affect the quality of the products. Thus, photomasks must be managed with particular accurateness so as to maximally eliminate any possibility of damage thereof.

### SUMMARY OF THE INVENTION

One primary objective of the present invention is to provide a photomask tracking system and a method thereof, wherein an RFID (Radio Frequency Identification) technology is used to allow a manager to recognize a latest progress of each photomask, and all movements in a handling process of photomasks are directly recorded and provided to a control terminal so as to achieve more effective and real-time management of the photomask handling process.

Another primary objective of the present invention is to provide a photomask tracking system and a method thereof for continuously monitoring a storage status of a photomask.

Another primary objective of the present invention is to provide a photomask tracking system and a method thereof for rapidly identifying a storage position of a photomask pod.

Still another primary objective of the present invention is to provide a photomask tag that is attached to a photomask pod for being automatically sensed so that the photomask is prevented from being damaged while being tracked.

Yet another primary objective of the present invention is to provide a photomask tracking system and a method thereof wherein a database accurately recording photomask data is established and relying on the data in the database, a use life and storage status of photomasks can be improved so as to save costs and enhance managing efficiency.

To achieve these objectives, the present invention firstly provides a photomask tracking system used in a photomask handling system for automatically tracking a photomask during a photomask handling process.

The photomask handling system comprises at least one photomask handling apparatus and at least one photomask pod. The photomask handling apparatus may be a photomask stocker, a photomask cleaner, a photomask transporter, and an exposure apparatus required in an optical lithographic process or other handling apparatuses required in the photomask handling process. The photomask pod may be of two types, namely a photomask transporting pod for carrying a photomask during transportation, and a photomask storage pod for storing a photomask in the photomask stocker.

The disclosed photomask tracking system comprises at least one RFID tag, at least one RFID reader and a control terminal, wherein the RFID tag is deposited on or attached to the photomask pod that is to be combined with the handling apparatuses. The RFID tag transmits a signal through an RFID mechanism. The RFID tag is detachable so that when the photomask is transferred between the photomask transporting pod and the photomask storage pod, the RFID tag can be detached from one said photomask pod where the photomask leaves and reattached to the other said photomask pod where the photomask enters.

The RFID tag transmits a first signal through the RFID mechanism and the first signal expresses data of the photomask carried by the photomask pod. The RFID reader at the handling apparatus receives the first signal from the photomask pod before, while or after handling the photomask and transmits a second signal expressing a latest progress of the photomask at the handling apparatus to the control terminal. The control terminal automatically receives the second signal from the handling apparatus so as to record the handling process of the photomask and track the latest progress of the photomask.

The control terminal may be equipped with a database that automatically records and stores all basic data of all photomasks, such as photomask numbers, photomask types, manufacturing dates and manufacturers, and also records the whole handling process of the photomasks, including duration of each handling step, frequencies of coming in and going out each handling apparatus, and sequence of entering the handling apparatuses.

The present invention further provides a photomask tracking method used in a photomask handling system. The photomask tracking method comprises steps of: providing the photomask tracking system and using an RFID tag to transmit a first signal before, while or after handling apparatuses handle the photomask, using an RFID reader to receive the first signal and transmit a second signal, and using a control terminal to receive the second signal so as to record a handling process of the photomask.

The proposes of the present invention allow an automatic management of photomasks so as to prevent damage of the photomasks caused by human mistake, and thereby lengthen a use time of the photomasks. Besides, the RFID system used in the present invention can provide a manager with a latest progress of photomasks so that the manager can track the photomask while the photomask is handled and transferred. Furthermore, by accurately recording data of the photomasks, use and storage status of the photomasks can be well managed.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a flow chart of a photomask handling process;

FIG. 2 is a schematic drawing showing a photomask tracking system according to the present invention; and

FIG. 3 is a schematic drawing showing a photomask pod and an RFID tag attached thereon according to the present invention.

### DETAILED DESCRIPTION OF THE PREFERRED EMBODIMENT

While the present invention proposes a photomask tracking system implementing an RFID (Radio Frequency Identification) technology, the accompanying drawings for being read in conjunction with the following descriptions aim to express structural features related to the characteristics of the present invention and thus are not, and do not need to be, made in scale.

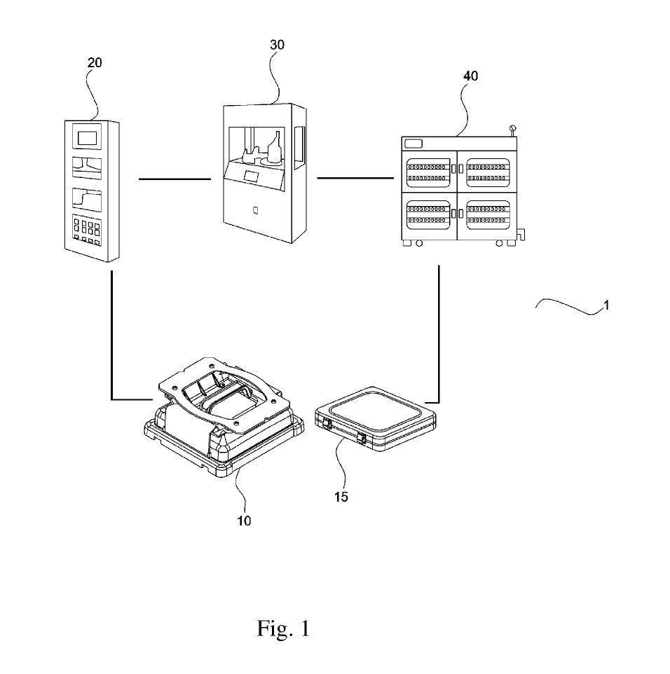

First, please refer to FIG. 1 for a schematic drawing illustrating a conventional photomask handling process 1. Therein, a photomask transporter 20 is provided for transporting photomasks. A photomask cleaner 30 cleans used photomasks by removing contaminant on the photomasks. A photomask stocker 40 is always filled with an inert gas so as to isolate a photomask pod from the atmosphere and ensure an article contained in the photomask pod against external contamination. At least one photomask pod 10 or 15, wherein the photomask pod may be of two types, namely a photomask transporting pod 10 for carrying a photomask during transportation and a photomask storage pod 15 for storing a photomask in the photomask stocker 40.

In the conventional photomask handling process 1, an operator places a photomask into the photomask transporting pod 10, and puts the photomask transporting pod 10 into the photomask transporter 20. Then when the photomask transporting pod 10 is transported to the photomask cleaner 30, the operator takes the photomask (not shown) out of the photomask transporting pod 10 and places the photomask into the photomask cleaner 30. After cleaning is performed, the operator puts the photomask into the photomask storage pod 15 and places the photomask storage pod 15 into the photomask stocker 40. In the aforementioned process, all movement, recording and operating have to be manually conducted.

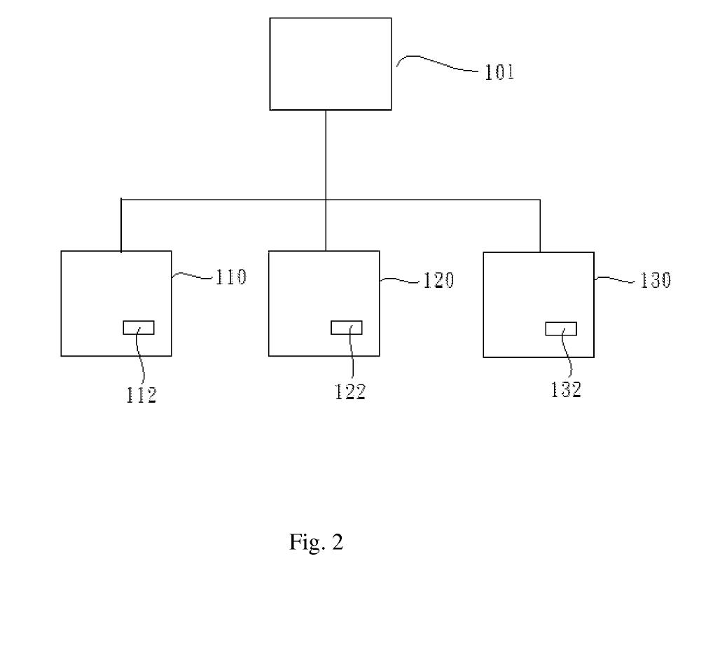

Please refer to FIG. 2 for a schematic drawing illustrating a photomask tracking system of the present invention using an RFID technology. The photomask tracking system using the RFID technology according to the present invention comprises: a control terminal 101, a plurality RFID readers 112 deposited on handling apparatuses 110, 120 and 130, wherein the handling apparatuses may comprise a photomask transporter 110, a photomask cleaner 120, a photomask stocker 130, an exposure apparatus required in an optical lithographic process or other handling apparatuses required in the photomask handling process for reading RFID signals and transmitting signals to the control terminal 101, which may be at least one electronic calculator.

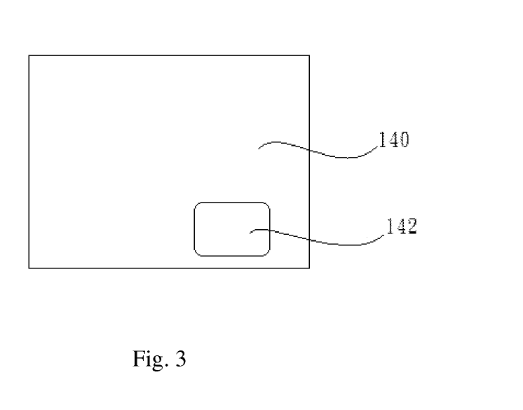

Now referring to FIG. 3, a schematic drawing illustrates a photomask pod 140 and an RFID tag 142 attached thereon according to the present invention, wherein the photomask pod 140 may be a said photomask storage pod 15 or a said photomask transporting pod 10.

When the photomask is handled by the handling apparatuses, the RFID tag 142 on the photomask storage pod or the photomask transporting pod 140 transmits a first signal to the handling apparatuses 110, 120, and 130 through the RFID mechanism. The first signal is to express data of the photomask carried by the photomask pod 140. Meantime, the RFID readers 112, 122, and 132 on the handling apparatuses 110, 120, and 130 receive the first signal from the photomask pod 140 and transmit a second signal to the control terminal 101 before, while or after the handling apparatuses handle the photomask, wherein the second signal is to express a latest progress of the photomask at the handling apparatuses 110, 120 and 130. The control terminal 101, which further comprises a record device (not shown), receives the second signals from the handling apparatuses 110, 120 and 130 so as to record data of the handling process of the photomask at the handling apparatuses and tracks the latest progress of the photomask. The data of the photomask handling process comprise a cleaning record, a transporting record and a storage time of the photomask.

In the present invention, signal communication between the control terminal 101 as well as the RFID tag 142 and the RFID readers 112, 122 and 132 can be achieved by either a wireless or wired manner. Each said RFID tag 142 has a unique identification code and is recyclable. Furthermore, the RFID tag 142 is detachable, so that when the photomask is transferred between the photomask transporting pod and the photomask storage pod, the RFID tag can be detached from one of the photomask pods 140 where the photomask leaves and reattached to the other photomask pod 140 where the photomask enters.

In another preferred embodiment of the present invention, the RFID tag 142 is switchable. Each said photomask transporting pod 10 and each said photomask storage pod 15 come as a pair and share a common identification code. When the photomask is taken out of the photomask storage pod 15 and transferred to the photomask transporting pod 10, a manager can simply turns off a function switch of the RFID tag 142 on the photomask storage pod 15 and turns on a function switch of the RFID tag 142 on the photomask transporting pod 10 without a need of detaching the RFID tag 142 from the photomask storage pod 15 and reattaching it to the photomask transporting pod 10, thereby allowing the manager to transfer the photomask conveniently.

Referring to FIGS. 1 and 2 again, the present invention further provides a photomask tracking method used in a photomask handling system. The photomask tracking method comprises the following steps: providing the photomask tracking system as described above, then using the RFID tag 142 to transmit a first signal before, while or after the handling apparatuses handle the photomask, using the RFID readers 112, 122, and 132 to receive the first signal and send a second signal, using the control terminal 101 to receive the second signal and thereby record a handling process of the photomask.

Now the reference is made to FIG. 3. Therein, the photomask pods 140 of the photomask handling system at least comprises one said photomask transporting pod 10 for transmitting the photomask, one said photomask storage pod 15 for storing the photomask. The photomask transporting pod 10 and the photomask storage pod 15 are attached by the RFID tags 142 containing identification codes that are at least partially identical and being switchable so that when the photomask is transferred between the photomask transporting pod 10 and photomask storage pod 15, the photomask tracking method further comprises a step of: turning off the RFID tag 142 at the photomask pod 140 where the photomask leaves and turning on the other RFID tag 142 at the photomask pod 140 where the photomask enters.

Although the particular embodiments of the invention have been described in detail for purposes of illustration, it will be understood by one of ordinary skill in the art that numerous variations will be possible to the disclosed embodiments without going outside the scope of the invention as disclosed in the claims.

What is claimed is:

1. A photomask tracking system used in a photomask handling system, wherein the photomask handling system includes at least one photomask transporting pod for transporting at least one photomask, a photomask storage pod for storing the photomask, and at least one handling apparatus for handling the photomask, and the photomask tracking system comprises:
at least one RFID tag, provided on the photomask transporting pod and/or the photomask storage pod for transmitting a first signal through an RFID (Radio Frequency Identification) principle, and being detachable, so that when the photomask is transferred between the photomask transporting pod and the photomask storage pod, the RFID tag can be detached from one of the photomask pods where the photomask leaves and attached to the other photomask pod where the photomask enters;
at least one RFID reader, provided on the handling apparatus for receiving the first signal before, while or after the handling apparatus handles the photomask, and transmitting a second signal; and
a control terminal, receiving the second signal and having a record device for storing data of a handling process of the photomask.

2. The photomask tracking system of claim 1, wherein the data of the handling process of the photomask comprise a cleaning record, a transporting record and a storage time of the photomask.

3. The photomask tracking system of claim 1, wherein each said RFID tag has a unique identification code.

4. The photomask tracking system of claim 1, wherein the handling apparatus is a photomask stocker, a photomask cleaner, a photomask transporter or an exposure apparatus used in an optical lithographic process.

5. The photomask tracking system of claim 1, wherein the RFID tag can be used repeatedly.

6. The photomask tracking system of claim 1, wherein the control terminal comprises at least one computer.

7. The photomask tracking system of claim 1, wherein the reader transmits the second signal to the control terminal by a wired or a wireless manner.

8. The photomask tracking system of claim 1, the RFID tags on the photomask transporting pod and the photomask storage pod comprises identification codes that are at least partially identical and the RFID tags are switchable so that when the photomask is transferred between the photomask transporting pod and photomask storage pod, the RFID tag on the photomask pod where the photomask leaves is turned off and the other RFID tag at the photomask pod where the photomask enters is turned on.

9. A photomask tracking method used in a photomask handling system, wherein the photomask handling system includes at least one photomask pod, and at least one handling apparatus for handling the photomask, and the photomask tracking method comprises steps of:
providing a photomask tracking system, which comprises:
at least one RFID tag, provided on the photomask pod and transmitting a first signal through an RFID (Radio Frequency Identification) principle;
at least one RFID reader, provided on the handling apparatus; and
a control terminal; and
using the RFID tag to transmit a first signal before, while or after the handling apparatus handles the photomask, using the RFID reader to receive the first signal and transmit a second signal, and using the control terminal to receive the second signal and thereby record a handling process of the photomask.

10. The photomask tracking method of claim 9, wherein each said RFID tag has a unique identification code.

11. The photomask tracking method of claim 9, wherein the photomask pod is a photomask transporting pod.

12. The photomask tracking method of claim 9, wherein the photomask pod is a photomask storage pod.

13. The photomask tracking method of claim 9, wherein the control terminal comprises at least one computer.

14. The photomask tracking method of claim 9, wherein the RFID reader transmits the second signal to the control terminal by a wired or a wireless manner.

15. The photomask tracking method of claim 9, wherein the photomask pod of the photomask handling system includes at least one photomask transporting pod for transporting the photomask and one photomask storage pod for storing the photomask, in which the photomask transporting pod and the photomask storage pod have the RFID tags containing identification codes that are at least partially identical and being switchable so that when the photomask is transferred between the photomask transporting pod and photomask storage pod, the photomask tracking method further comprises steps of turning off the RFID tag at the photomask pod where the photomask leaves and turning on the other RFID tag at the photomask pod where the photomask enters.

16. The photomask tracking method of claim 9, wherein the photomask pod of the photomask handling system comprises at least one photomask transporting pod for transporting the photomask and one photomask storage pod for storing the photomask, and the RFID tag is detachable so that when the photomask is transferred between the photomask transporting pod and the photomask storage pod, the photomask tracking method further comprises steps of detaching the RFID tag from one said photomask pod where the photomask leaves and reattaching the RFID tag to the other said photomask pod where the photomask enters.
